(19) United States
(12) Patent Application Publication
(10) Pub. No.: US 2025/0045875 A1
(43) Pub. Date: Feb. 6, 2025

(54) IMAGE CORRECTION DEVICE, IMAGE CORRECTION METHOD, AND IMAGE CORRECTION PROGRAM

(71) Applicant: NIPPON TELEGRAPH AND TELEPHONE CORPORATION, Tokyo (JP)

(72) Inventors: Shogo SATO, Tokyo (JP); Yasuhiro YAO, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/716,828

(22) PCT Filed: Dec. 7, 2021
(86) PCT No.: PCT/JP2021/044999

§ 371 Date: Jun. 5, 2024

(51) Int. Cl. G06T 5/50; G06T 5/70; G06T 7/13; G06T 7/90; G06V 10/44; G06V 10/60; G06V 10/762; G06V 20/70

(52) U.S. Cl. CPC G06T 5/50; G06T 5/70; G06T 7/13; G06T 7/90; G06V 10/44; G06V 10/60; G06V 10/7635; G06V 20/70; G06T 2207/10024; G06T 2207/10028

(57) ABSTRACT

An input processing unit receives an image and a three-dimensional point cloud including three-dimensional points having reflection intensity on a surface of an object for which at least a relationship between an image capturing position and a measurement position is obtained in advance, and obtains pixel positions on the image corresponding to the respective three-dimensional points of the three-dimensional point cloud. A shadow region estimation unit performs clustering on pixels of the image on the basis of pixel values and pixel positions, obtains an average reflection intensity and an average value of quantified color information for each of clusters, and estimates a shadow region by performing comparison in the average reflection intensity and the average value of the color information between the clusters. A shadow correction unit corrects pixel values of the shadow region from the shadow region estimated and the image.

### TECHNICAL FIELD

The disclosed technology relates to an image correction device, an image correction method, and an image correction program.

### BACKGROUND ART

Non Patent Literature 1 discloses a technology of mapping reflection intensity measured by LiDAR on an image, extracting a shadow boundary part on the basis of gradient information on the reflection intensity and gradient information of color, deriving an average value of quantified color information of each of sunshine and shadow, and detecting the shadow by graph cut.

### CITATION LIST

### Non Patent Literature

Non Patent Literature 1: M. Guislain, J. Digne, R. Chaine, D. Kudelski and P. Lefebvre-Albaret, “Detecting and Correcting Shadows in Urban Point Clouds and Image Collections,” 2016 Fourth International Conference on 3D Vision (3DV), 2016.

### SUMMARY OF INVENTION

### Technical Problem

In the technology described in Non Patent Literature 1, shadow boundary information cannot be directly used in shadow detection. For this reason, there is a possibility that detection omission of shadow occurs in a case where a substance having a high surface reflectance is present in shade. In addition, there is a possibility that an object having low reflectance present in the sunshine is detected as shadow. In addition, if measurement is performed with a measuring instrument having a large error in reflection intensity, a shadow boundary cannot be correctly detected. In addition, there is a possibility that a boundary portion of shadow is unnatural at the time of shadow correction.

The disclosed technology has been made in view of the above points, and an object thereof is to provide an image correction device, an image correction method, and an image correction program capable of accurately estimating a shadow region and correcting an image.

### Solution to Problem

A first aspect of the present disclosure is an image correction device including: an input processing unit that receives an image and a three-dimensional point cloud including three-dimensional points having reflection intensity on a surface of an object for which at least a relationship between an image capturing position and a measurement position is obtained in advance, and obtains pixel positions on the image corresponding to the respective three-dimensional points of the three-dimensional point cloud; a shadow region estimation unit that performs clustering on pixels of the image on the basis of pixel values and pixel positions, obtains an average reflection intensity and an average value of quantified color information for each of clusters, and estimates a shadow region by performing comparison in the average reflection intensity and the average value of the color information between the clusters; and a shadow correction unit that corrects pixel values of the shadow region from the shadow region estimated and the image.

A second aspect of the present disclosure is an image correction method including: by an input processing unit, receiving an image and a three-dimensional point cloud including three-dimensional points having reflection intensity on a surface of an object for which at least a relationship between an image capturing position and a measurement position is obtained in advance, and obtaining pixel positions on the image corresponding to the respective three-dimensional points of the three-dimensional point cloud; by a shadow region estimation unit, performing clustering on pixels of the image on the basis of pixel values and pixel positions, obtaining an average reflection intensity and an average value of quantified color information for each of clusters, and estimating a shadow region by performing comparison in the average reflection intensity and the average value of the color information between the clusters; and by a shadow correction unit, correcting pixel values of the shadow region from the shadow region estimated and the image.

A third aspect of the present disclosure is an image correction program, and is program for causing a computer to function as the image correction device of the first aspect.

### Advantageous Effects of Invention

According to the disclosed technology, it is possible to accurately estimate a shadow region and correct an image.

### BRIEF DESCRIPTION OF DRAWINGS

FIG. 1 is a schematic block diagram of an example of a computer that functions as an image correction device of a present embodiment.

FIG. 2 is a diagram illustrating an example of measurement points by a LiDAR sensor and an image capturing scene by a camera.

FIG. 3 is a block diagram illustrating a configuration of the image correction device of the present embodiment.

FIG. 4 is a block diagram illustrating a configuration of an intensity correction unit of the image correction device of the present embodiment.

FIG. 5 is a diagram illustrating an example of a result of projecting a three-dimensional point cloud onto an image.

FIG. 6 is a block diagram illustrating a configuration of a shadow region estimation unit of the image correction device according to the present embodiment.

FIG. 7 is a diagram illustrating an example of the image.

FIG. 8 is a diagram illustrating an example of a result of performing clustering on pixels of the image.

FIG. 9 is a diagram for explaining a boundary in the image.

FIG. 10 is a diagram for explaining boundaries in a reflection intensity map.

FIG. 11 is a flowchart illustrating an image correction routine of the image correction device of the present embodiment.

FIG. 12 is a flowchart illustrating a flow of processing of generating a reflection intensity map in the image correction device of the present embodiment.

FIG. 13 is a flowchart illustrating a flow of processing of estimating a shadow region in the image correction device of the present embodiment.

### DESCRIPTION OF EMBODIMENTS

Hereinafter, an example of an embodiment of the disclosed technology will be described with reference to the drawings. Note that same or equivalent components and parts are denoted by the same reference numerals in the drawings. In addition, dimensional ratios in the drawings are exaggerated for convenience of description and thus may be different from actual ratios.

### Overview of Present Embodiment

In a conventional technology, due to that shadow boundary information is not directly used, it may occur that detection of shadow is omitted due to a substance having a high surface reflectance present in shade, or a substance having a low reflectance present in sunshine is detected as shadow.

In the present embodiment, a shadow boundary is extracted on the basis of a cluster graph on the basis of reflection intensity measured by a LiDAR sensor and a luminance value of an image captured by a camera, whereby a shadow region is accurately estimated while influence on difference in reflectance for each of substances is suppressed.

In addition, in the conventional technology, in a case where an observation result by a measuring instrument having a large error in reflection intensity is used, a boundary of a shadow region may not be correctly detected.

In the present embodiment, the reflection intensity measured by the LiDAR sensor is corrected, whereby the boundary of the shadow region is accurately estimated even in a case where observation data of a measuring instrument having a large error in reflection intensity is used.

In addition, in the conventional technology, in a case where pixel values of the shadow region are corrected, color information on the shadow region may be unnatural as compared with a sunshine region.

In the present embodiment, the pixel values of the shadow region are corrected on the basis of information on the shadow region accurately estimated so that the color information on the shadow region is natural as compared with the sunshine region.

### <Configuration of Image Correction Device According to Present Embodiment>

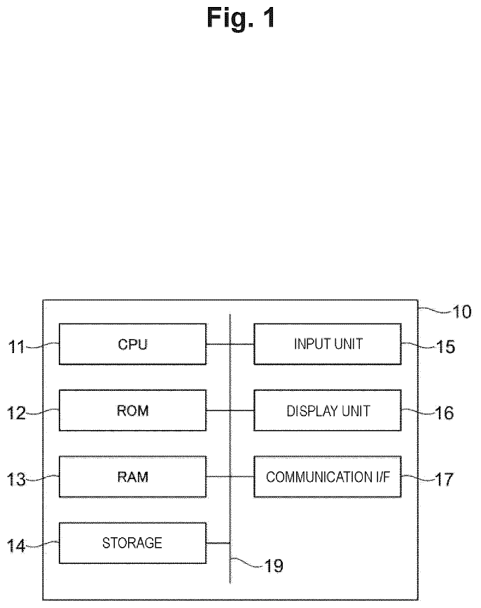

FIG. 1 is a block diagram illustrating a hardware configuration of an image correction device 10 according to the present embodiment.

As illustrated in FIG. 1, the image correction device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, executes various programs, and controls each unit. That is, the CPU 11 reads a program from the ROM 12 or the storage 14, and executes the program using the RAM 13 as a working area. The CPU 11 performs control of each of the components described above and various types of calculation processing according to a program stored in the ROM 12 or the storage 14. In the present embodiment, the ROM 12 or the storage 14 stores an image correction program for correcting an image using a three-dimensional point cloud. The image correction program may be one program or a group of programs including a plurality of programs or modules.

The ROM 12 stores various programs and various types of data. The RAM 13, as a work area, temporarily stores programs or data. The storage 14 includes a hard disk drive (HDD) or a solid state drive (SSD) and stores various programs including an operating system and various types of data.

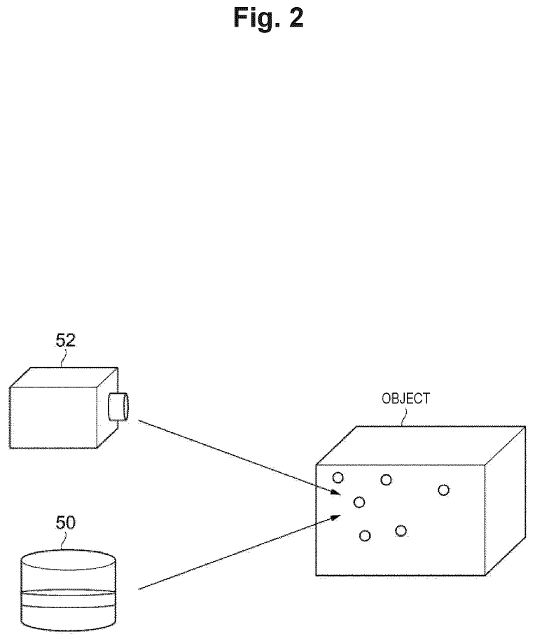

The input unit 15 includes a pointing device such as a mouse and a keyboard, and is used to perform various inputs including a captured image I and a three-dimensional point cloud P on a surface of an object for which at least a relationship between an image capturing position and a measurement position is obtained in advance. For example, as illustrated in FIG. 2, the three-dimensional point cloud P measured by a LiDAR sensor 50 and an image I captured by a camera 52 in an image capturing scene are input to the input unit 15. The relationship between the image capturing position of the camera 52 and the measurement position of the LiDAR sensor 50 are obtained in advance. FIG. 2 illustrates an example in which a three-dimensional point cloud indicated by a white circle on a surface of an object included in the image capturing scene by the camera 52 is measured by the LiDAR sensor 50.

The image I is a distortion-corrected RGB or grayscale image. The three-dimensional point cloud P is a set of three-dimensional points measured by the LiDAR sensor 50. Each three-dimensional point is a four-dimensional vector including a three-dimensional position and a one-dimensional reflection intensity, and in a case where the three-dimensional point cloud P includes N three-dimensional points, the three-dimensional point cloud P is a set of four-dimensional vectors having N elements.

In addition, an internal parameter K of the camera 52, a projection matrix R between the camera 52 and the LiDAR sensor 50, and a translation vector L between the camera 52 and the LiDAR sensor 50 are input to the input unit 15.

The internal parameter K of the camera 52 is a 3×3 camera internal parameter matrix. The projection matrix R between the camera 52 and the LiDAR sensor 50 is a 3×3 rotation matrix. The translation vector L between the camera 52 and the LiDAR sensor 50 is a three-dimensional vector.

The display unit 16 is, for example, a liquid crystal display, and displays various types of information including an image corrected by using the three-dimensional point cloud P measured by the LiDAR sensor 50. The display unit 16 may function as the input unit 15 by adopting a touch panel system.

Specifically, the display unit 16 displays a reflection intensity map representing reflection intensity as a pixel value of each pixel, a shadow region mask representing a shadow region on the image I, and a corrected image obtained by correcting a pixel value (color information) of the shadow region.

The communication interface 17 is an interface for communicating with another device, and for example, standards such as Ethernet (registered trademark), FDDI, and Wi-Fi (registered trademark) are used.

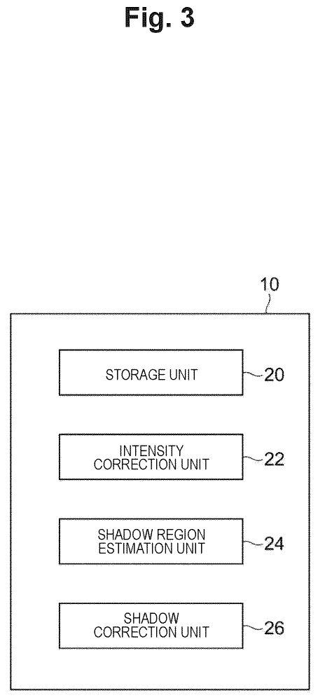

Next, a functional configuration of the image correction device 10 will be described. FIG. 3 is a block diagram illustrating an example of the functional configuration of the image correction device 10.

As illustrated in FIG. 3, the image correction device 10 functionally includes a storage unit 20, an intensity correction unit 22, a shadow region estimation unit 24, and a shadow correction unit 26.

The storage unit 20 stores the three-dimensional point cloud P measured by the LiDAR sensor 50 and the image I captured by the camera 52, which are input. In addition, the storage unit 20 stores the internal parameter K of the camera 52, the projection matrix R between the camera 52 and the LiDAR sensor 50, and the translation vector L between the camera 52 and the LiDAR sensor 50, which are input.

The intensity correction unit 22 generates a reflection intensity map in which reflection intensity is assigned to each pixel of the image I, on the basis of the three-dimensional point cloud P measured by the LiDAR sensor 50, the image I captured by the camera 52, the internal parameter K of the camera 52, the projection matrix R between the camera 52 and the LiDAR sensor 50, and the translation vector L between the camera 52 and the LiDAR sensor 50. In addition, the intensity correction unit 22 corrects the generated reflection intensity map on the basis of the image I.

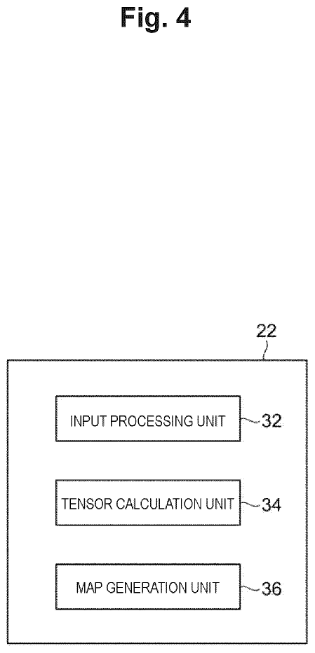

Specifically, as illustrated in FIG. 4, the intensity correction unit 22 includes an input processing unit 32, a tensor calculation unit 34, and a map generation unit 36.

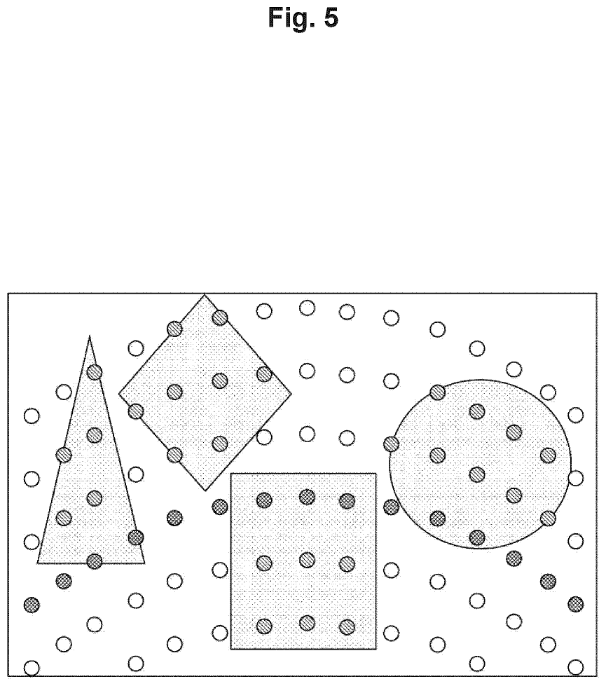

The input processing unit 32 projects each three-dimensional point of the three-dimensional point cloud P onto the image I on the basis of the image I, the three-dimensional point cloud P, the internal parameter K, the projection matrix R, and the translation vector L, and obtains a pixel position on the image I corresponding to each three-dimensional point (see FIG. 5). FIG. 5 illustrates an example in which each three-dimensional point on a surface of an object represented by a dot is projected onto the image I, and color density of the dot represents magnitude of the reflection intensity. In addition, the example is illustrated in which the LiDAR sensor 50 includes a plurality of elements, three-dimensional points measured by one element are projected to be arranged in a line, and the reflection intensity of one line of three-dimensional points measured by a certain element is relatively large. That is, the example is illustrated in which the reflection intensity different for each element is measured even on the object surface where the reflection intensity should have the same value.

Calculation when the input processing unit 32 projects the three-dimensional point cloud P onto the image I is similar to a method described in Non Patent Literature 2.
Non Patent Literature 2: A. Geiger, P. Lenz, C. Stiller, and R. Urtasun, “Vision Meets Robotics: The KITTI Dataset,” The International Journal of Robotics Research 32, 2013.

Specifically, each three-dimensional point of the three-dimensional point cloud P is projected onto the image I, and three-dimensional points projected outside a region of the image I is removed from the three-dimensional point cloud P. A set Q is obtained including an element that is a combination of a pixel position and reflection intensity corresponding to each three-dimensional point of the three-dimensional point cloud P after the removal on the image I.

For example, a three-dimensional point cloud from which only position information is extracted from the three-dimensional point cloud P is referred to as a three-dimensional point cloud P_1. The three-dimensional point cloud P_1 is a set of three-dimensional vectors having N elements. For each of the three-dimensional points included in the three-dimensional point cloud P_1, a three-dimensional point cloud P_2 is obtained by applying the projection matrix R and the translation vector L in accordance with the following formula. The three-dimensional point cloud P_2 is a set of N three-dimensional vectors.

$$P\_ 2 = R •P\_ 1 + L$$

The three-dimensional point cloud P_2 is projected onto the image I of the camera 52 with the internal parameter K, and three-dimensional points projected outside the region of the image I is removed, and regarding three-dimensional points whose projected positions overlap, a three-dimensional point having a shorter distance from the camera 52 is adopted. By this calculation, the set Q of elements q is obtained including (an x coordinate in the image I, a y coordinate in the image I, reflection intensity).

Note that association between each element of the set Q and each three-dimensional point of the three-dimensional point cloud P before conversion is maintained. Each element of the set Q is mapped to the image I, and a reflection intensity map before correction is generated.

The tensor calculation unit 34 calculates an anisotropic diffusion tensor T for weighting a smoothing term on the basis of an image gradient on the basis of the image I.

The calculation of the anisotropic diffusion tensor is similar to a method described in Non Patent Literature 3.
Non Patent Literature 3: D. Ferstl, C. Reinbacher, R. Ranftl, M. Ruether and H. Bischof, “Image Guided Depth Upsampling Using Anisotropic Total Generalized Variation,” 2013 IEEE International Conference on Computer Vision, 2013, pp. 993-1000.

Specifically, the anisotropic diffusion tensor T for weighting the smoothing term for smoothing on the basis of the image gradient of an energy function to be described later is obtained from the image I. The anisotropic diffusion tensor T has 2×2 dimensions per pixel. A gradient N_1 of the image I is obtained by differentiating the image I in the x direction and the y direction. The element in a pixel (x, y) with the calculated gradient N_1 is a two-dimensional vector (an x-direction differential value, a y-direction differential value). Since the gradient cannot be defined at an image edge, a value of the nearest point is adopted as a gradient of an undefined region.

In each pixel of the gradient N_1, a gradient normalized such that a sum of squares of the x-direction differential value and the y-direction differential value is 1 is defined as N_2. In addition, a set of vectors obtained by calculating vertical unit vectors in respective pixels of the gradient N_2 is defined as N_3. The anisotropic diffusion tensor T is calculated from the gradients N_1, N_2, and N_3 in accordance with the following formula.

$$T = exp ( - a {\vert N\_ 1 \vert}^{b} ) ( ( N\_ 2 ) {( N\_ 2 )}^{′} ) + ( N\_ 3 ) {( N\_ 3 )}^{′}$$

In the above formula, a transposed matrix of a matrix A is expressed as A′. In the map generation unit 36, the reflection intensity map is corrected by the anisotropic diffusion tensor T by referring to the gradient of the image I.

The map generation unit 36 corrects the reflection intensity map in which reflection intensity is assigned to each pixel of the image I on the basis of a difference from reflection intensity of a three-dimensional point corresponding to a pixel position on the image I, and the anisotropic diffusion tensor T.

Specifically, a data term is calculated for each element q=(x_q, y_q, i_q) of the set Q. The data term can be evaluated only from a difference between the measured reflection intensity and the corrected reflection intensity, and a likelihood of each element g=(x_g, y_g, i_g) of a corrected reflection intensity map C is evaluated. Cost c_qg for the pixel (x, y) is obtained as follows.

$$c\_qg = w\_qg Distance ( i\_q , i\_g )$$

Distance is a distance between reflection intensity i_q assigned to the pixel (x, y) and reflection intensity i_g after the correction. The distance at this time is an l1 distance, an l2 distance, a Huber distance, or the like. A weight is w_qg, and w_qg=0 if the reflection intensity of the three-dimensional point measured is not projected onto the pixel (x, y). On the other hand, if the measured reflection intensity of the three-dimensional point is projected onto the pixel (x, y), the weight has a value (0<w_qg) determined depending on a degree of smoothing by the smoothing term of the energy function to be described later. That is, the cost c_qg means consistency with the reflection intensity i_q after the correction when the reflection intensity i_g of the three-dimensional point measured is assigned to the pixel (x, y).

Then, the corrected reflection intensity map C is generated and output by a Variational method for obtaining a function that minimizes a functional. In the present embodiment, the reflection intensity i_g of each pixel is obtained by the Variational method to minimize an energy function E_V below.

$$E\_V = {\sum }_{x , y} ( c\_qg + norm ( T ∇ i\_g ) )$$

Here, norm is an l1 distance, an l2 distance, a Huber distance, or the like, and truncation may be performed. T is an anisotropic diffusion tensor. Minimizing the energy function E_V can be performed by a first order primal dual algorithm described in Non Patent Literature 4. The corrected reflection intensity map C is obtained by minimizing the energy function E_V.
Non Patent Literature 4: Chambolle, A., Pock, T. A First-Order Primal-Dual Algorithm for Convex Problems with Applications to Imaging. J Math Imaging Vis 40, 120-145 (2011).

The shadow region estimation unit 24 performs clustering on the pixels of the image I on the basis of the pixel values and the pixel positions, integrates the clusters by using the corrected reflection intensity map, and obtains an average reflection intensity, an average pixel value, and an average value of the color information for each cluster. The shadow region estimation unit 24 performs comparison in the average reflection intensity and the average value of the color information between the clusters, estimates a shadow region, and outputs a shadow region mask representing the shadow region.

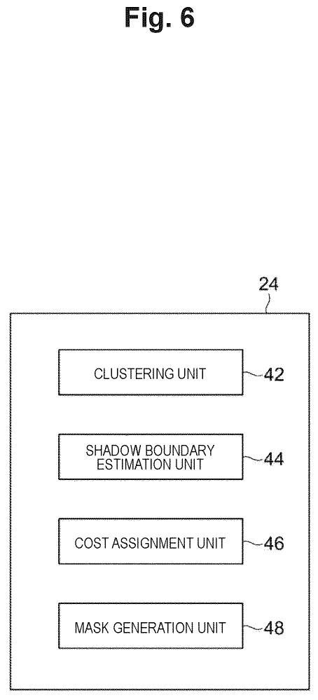

Specifically, as illustrated in FIG. 6, the shadow region estimation unit 24 includes a clustering unit 42, a shadow boundary estimation unit 44, a cost assignment unit 46, and a mask generation unit 48.

The clustering unit 42 performs clustering on the pixels of the image I on the basis of the pixel values, the pixel positions, and the corrected reflection intensity map of the image I, and obtains the average reflection intensity, the average pixel value, and the average value of the color information for each cluster.

Specifically, clustering is performed to collect pixels with close distances in a color space and a distance space, clusters are integrated on the basis of the reflection intensity, and the average reflection intensity, the average pixel value, and the average value of the color information are obtained for each cluster to construct a cluster graph G1.

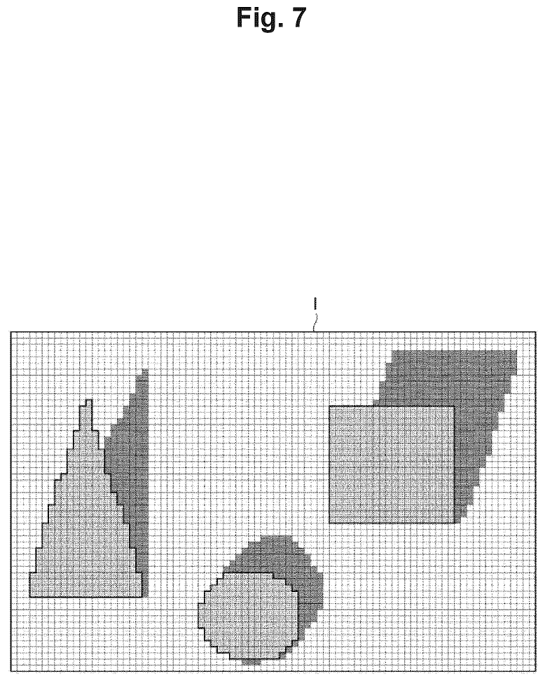

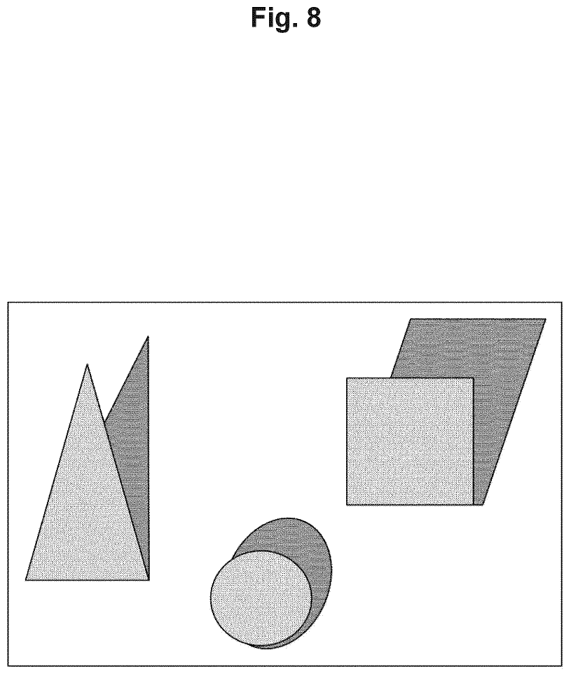

For example, clustering is performed on the image I illustrated in FIG. 7 to collect pixels with close distances in the color space and the distance space (see FIG. 8). FIG. 8 illustrates an example in which an image of 50 pixels×80 pixels is divided into seven clusters.

There are various clustering methods, and as an example, it is only required to use a SLIC method described in Non Patent Literature 5.

Each of nodes n of the cluster graph represent a cluster, and n=(b_n, i_n, lab_n) is defined. Here, b_n is an average value of color information in the cluster, i_n is an average reflection intensity in the cluster, and lab_n is an average Lab value (three dimensions) in the cluster. In addition, an edge is defined between adjacent clusters. That is, nodes representing adjacent clusters are connected to each other by edges.
Non Patent Literature 5: R. Achanta, A. Shaji, K. Smith, A. Lucchi, P. Fua and S. Susstrunk, “SLIC Superpixels Compared to State-of-the-Art Superpixel Methods,” in IEEE Transactions on Pattern Analysis and Machine Intelligence, 2012.

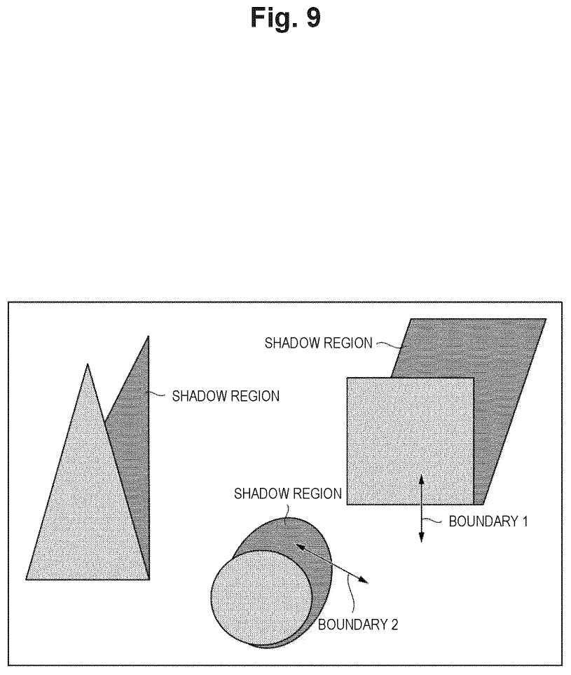

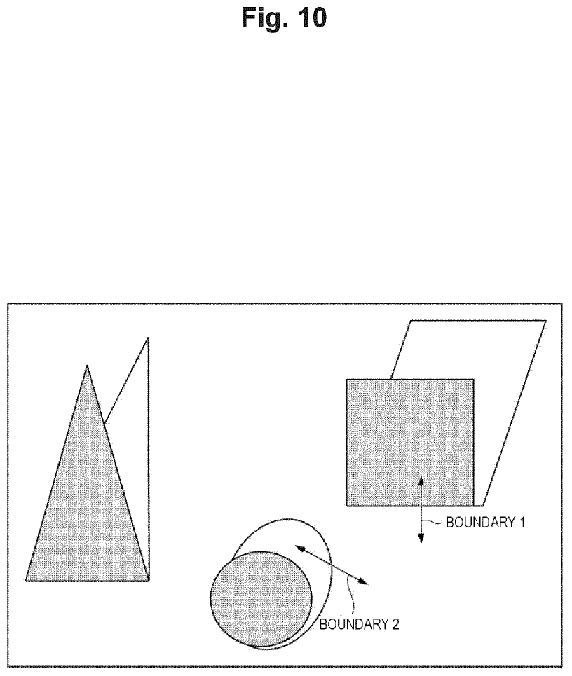

The shadow boundary estimation unit 44 performs comparison in the average reflection intensity and the average value of the color information between the adjacent clusters, and in a case where a difference in the average value of the color information is large and a difference in the average reflection intensity is small, estimates that a boundary between the adjacent clusters is a boundary of the shadow region (see FIGS. 9 and 10). Then, the shadow boundary estimation unit 44 assigns a sunshine label to a cluster having higher luminance and assigns a shadow label to a cluster having lower luminance among adjacent clusters sandwiching the boundary estimated to be the boundary of the shadow region, and assigns an unknown label to a cluster not including the boundary estimated to be the boundary of the shadow region.

FIG. 9 illustrates an example of an image in which luminance decreases since incident light is blocked in the shadow region. In addition, FIG. 10 illustrates an example of a reflection intensity map that does not depend on whether or not a region is the shadow region since the reflection intensity measured by the LiDAR sensor 50 depends on the reflection intensity of the object surface. Since both the luminance and the reflection intensity change at a boundary 1, it is determined that the boundary 1 is not a shadow boundary. At the boundary 2, since the luminance changes but the reflection intensity does not change, it is determined that the boundary 2 is a shadow boundary.

Specifically, an edge between adjacent clusters having a large difference in the average value of the color information and a small difference in the average reflection intensity is extracted from an edge of the cluster graph G1 as an edge having a high probability of being a boundary of the shadow region, and an edge set S extracted is obtained. Note that a color difference (such as CIEDE 2000) may be calculated as the difference in the color information.

Then, a label l_n is assigned to a node n connected to an edge belonging to the edge set S as follows.

A sunshine label (l_n=−1) indicating that a probability of being sunshine is high is assigned to a node n on a side where an average luminance is high. A shadow label (l_n=1) indicating that a probability of being shadow is high is assigned to a node n on a side where the average luminance is low.

In addition, an unknown label (l_n=0) indicating that it is uncertain whether a region is sunshine or shadowed is assigned to a node n that is not connected to the edge belonging to the edge set S. Note that a value of the label l_n may be any three values.

A cluster graph G2 is set as that obtained by assigning the labels to the nodes n of the cluster graph G1.

The cost assignment unit 46 adds, in the cluster graph, a source-side edge connecting each of the nodes representing the respective clusters to a source node, and a target-side edge connecting each of the nodes representing the respective clusters to a target node.

Then, the cost assignment unit 46 assigns a low edge cost to the source-side edge of a cluster to which the sunshine label is assigned and assigns a high edge cost to the target-side edge, and assigns a high edge cost to the source-side edge of a cluster to which the shadow label is assigned and assigns a low edge cost to the target-side edge.

In addition, the cost assignment unit 46 assigns, to the source-side edge of a cluster to which the unknown label is assigned, an edge cost depending on a distance between the color information on the cluster and an average value of the color information on the cluster to which the sunshine label is assigned, and assigns, to the target-side edge, an edge cost depending on a distance between the color information on the cluster and an average value of the color information on the cluster to which the shadow label is assigned.

Specifically, the cost assignment unit 46 adds the source node and the target node to the cluster graph G2, and connects each node n=(b_n, i_n, l_n, lab_n) to each of the source node and the target node. Then, the cost assignment unit 46 calculates, as the data term, an edge cost of the source-side edge connecting to the source node and an edge cost of the target-side edge connecting to the target node. The edge cost of the source-side edge is a value for evaluating a likelihood of sunshine, and the edge cost of the target-side edge is a value for evaluating a likelihood of shadow.

For example, an average value Ll of the color information is calculated from a node set with the sunshine label (l_n=−1), and an average value Ls of the color information is calculated from a node set with the shadow label (l_n=1).

In addition, as described below, an edge cost depending on the label l_n is assigned to each of the source-side edge and the target-side edge of the node n.

For a node with the shadow label (l_n=+1), the edge cost of the source-side edge is set as c1, and the edge cost of the target-side edge is set as c2. Here, c1<c2 is defined, and c1 and c2 are predefined constants.

In addition, for a node with the sunshine label (l_n=−1), the edge cost of the source-side edge is set as c2, and the edge cost of the target-side edge is set as c1.

In addition, for a node with the unknown label (l_n=0), the edge cost of the source-side edge is set as Distance(b_n, Ls), and the edge cost of the target-side edge is set as Distance(b_n, Ll). Here, Distance(i, j) is a distance between i and j, and is generally an l1 distance, an l2 distance, or the like.

As a result, it becomes easy to determine that a region having a high probability of being shadow is shadow, and it becomes easy to determine that a region having a high probability of being sunshine is sunshine. In a region with the unknown label, the likelihood of shadow is determined by the luminance value.

A cluster graph G3 is set as that obtained by adding the source node, the target node, the source-side edge, and the target-side edge to the cluster graph G2 and assigning the edge cost as described above.

The mask generation unit 48 estimates a shadow region by determining whether or not each of the clusters is a shadow region on the basis of the edge cost of the source-side edge and the edge cost of the target-side edge of each of the clusters, and generates a shadow region mask representing the estimated shadow region.

Specifically, a smoothing term is added to each edge of the cluster graph G3, and the shadow region is estimated by graph cut. Here, the smoothing term indicates an edge cost for connecting adjacent clusters to each other.

The mask generation unit 48 may use any binarization image processing method in consideration of the above-described data term, but a preferable image processing method is a graph cut segmentation method. At this time, it is only required to use a luminance distance Distance(b_n1, b_n2) between the adjacent nodes n1=(b_n1, i_n1, l_n1, lab_n1) and n2=(b_n2, i_n2, l_n2, lab_n2) as the smoothing term. The graph cut segmentation method is a known image processing method.

In addition, a label k_n is assigned to all the nodes n of the cluster graph G3 by a binarization processing method. That is, the label k_n=−1 is assigned to a node n determined to be in the sunshine, and a label k_n=1 is assigned to a node n determined to be in the shadow.

Then, −1 or 1 is assigned to each pixel corresponding to the cluster represented by the nodes n of the cluster graph G3 depending on the label k_n, and a shadow region mask representing the shadow region is generated. Here, the pixel value and k_n of the shadow region mask may be any binary values.

In addition, a cluster graph G4 is set as that obtained by adding the label k_n to each node of the cluster graph G3. The mask generation unit 48 outputs the cluster graph G4 and the shadow region mask.

The shadow correction unit 26 corrects the pixel values of the shadow region from the estimated shadow region and the image I.

Specifically, the pixel values of the shadow region are corrected on the basis of information (l_n, k_n) of each node of the cluster graph G4 and the image I.

For example, an average Lab value is calculated from each of the node set with the label l_n=−1 and the node set with l_n=1, and is set as (lab_l, lab_s).

In addition, the following calculation is performed for each node n=(b_n, i_n, l_n, lab_n).

In a case where the label k_n=−1 is set, the pixel value of each pixel in the cluster is not corrected and is left as it is. In addition, in a case where the label k_n=1 and l_n=1 are set, a Lab value (lab_m) of a node m connected to the node n in the edge belonging to the set S is corrected to be a Lab value of each pixel in the cluster.

In addition, in a case where the label k_n=1 and the label l_n≠1 are set, a Lab value calculated by the following formula is corrected to be the Lab value of each pixel in the cluster.

$$Lab value = lab\_n ⋆ ( lab\_l / lab\_s )$$

As described above, the shadow correction unit 26 corrects the Lab value of each pixel of the cluster determined to be the shadow region of the image I by using the Lab value of the adjacent cluster or the Lab value of the cluster determined to be sunshine. Note that an RGB value of each pixel of the cluster determined to be the shadow region may be corrected by using an RGB value of the adjacent cluster or an RGB value of the cluster determined to be sunshine.

### <Operation of Image Correction Device According to Present Embodiment>

Next, operation of the image correction device 10 will be described.

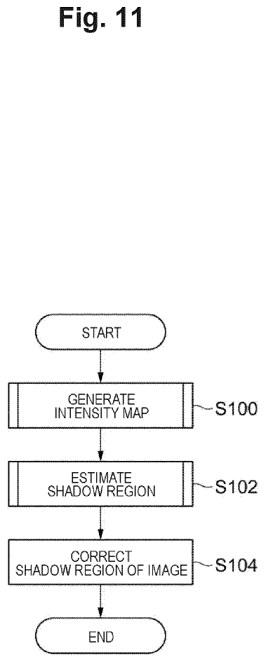

FIG. 11 is a flowchart illustrating a flow of image correction processing by the image correction device 10. The CPU 11 reads an image correction program from the ROM 12 or the storage 14, develops the image correction program in the RAM 13, and executes the image correction program, whereby image correction processing is performed. In addition, the three-dimensional point cloud P measured by the LiDAR sensor 50 and the image I captured by the camera 52 are input to the image correction device 10. In addition, it is assumed that the internal parameter K of the camera 52, the projection matrix R between the camera 52 and the LiDAR sensor 50, and the translation vector L between the camera 52 and the LiDAR sensor 50 have been input to the image correction device 10.

In step S100, the CPU 11, as the intensity correction unit 22, generates the reflection intensity map in which the reflection intensity is assigned to each pixel of the image I on the basis of the three-dimensional point cloud P, the image I, the internal parameter K, the projection matrix R, and the translation vector L. In addition, the CPU 11, as the intensity correction unit 22, corrects the generated reflection intensity map on the basis of the image I.

In step S102, the CPU 11, as the shadow region estimation unit 24, performs clustering on the pixels of the image I on the basis of the pixel values and the pixel positions, integrates the clusters by using the corrected reflection intensity map, and obtains the average reflection intensity, the average pixel value, and the average value of the color information for each cluster. In addition, the CPU 11, as the shadow region estimation unit 24, performs comparison in the average reflection intensity and the average value of the color information between the clusters, estimates the shadow region, and outputs the shadow region mask representing the shadow region.

In step S104, the CPU 11, as the shadow correction unit 26, corrects the pixel values of the shadow region from the estimated shadow region and the image I, displays the reflection intensity map, the shadow region mask, and the corrected image on the display unit 16, and ends an image correction routine.

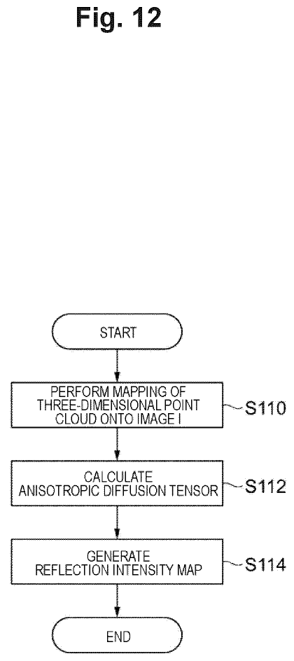

Step S100 described above is implemented by a processing routine illustrated in FIG. 12.

In step S110, the CPU 11, as the input processing unit 32, performs mapping of projecting each three-dimensional point of the three-dimensional point cloud P onto the image I on the basis of the image I, the three-dimensional point cloud P, the internal parameter K, the projection matrix R, and the translation vector L, and obtaining the pixel position onto the image I corresponding to each three-dimensional point.

In step S112, the CPU 11, as the tensor calculation unit 34, calculates the anisotropic diffusion tensor T that weights the smoothing term on the basis of the image gradient.

In step S114, the CPU 11, as the map generation unit 36, corrects the reflection intensity map in which the reflection intensity is assigned to each pixel of the image I on the basis of the difference from the reflection intensity of the three-dimensional point corresponding to the pixel position on the image I and the anisotropic diffusion tensor T, thereby generating the corrected reflection intensity map.

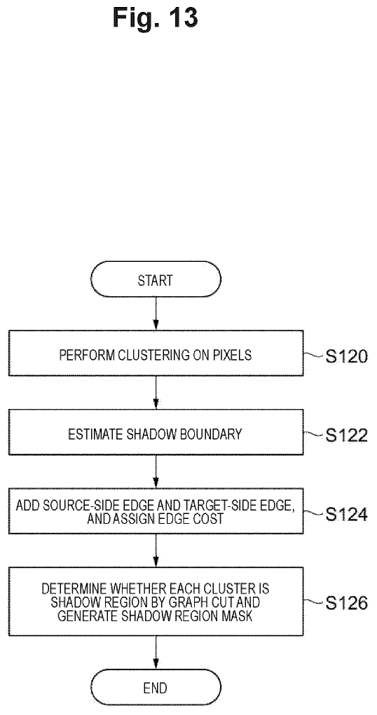

Step S102 described above is implemented by a processing routine illustrated in FIG. 13.

In step S120, the CPU 11, as the clustering unit 42, performs clustering on the pixels of the image I on the basis of the pixel values, the pixel positions, and the reflection intensity map of the image I, and obtains the average reflection intensity, the average pixel value, and the average value of the color information for each cluster.

In step S122, the CPU 11, as the shadow boundary estimation unit 44, performs comparison in the average reflection intensity and the average value of the color information between the adjacent clusters, and estimates that the boundary between the adjacent clusters is the boundary of the shadow region in a case where the difference in the average value of the color information is large and the difference in the average reflection intensity is small.

In step S124, the CPU 11, as the cost assignment unit 46, adds the source-side edge connecting each of the nodes representing the respective clusters to the source node, and the target-side edge connecting each of the nodes representing the respective clusters to the target node. Then, the CPU 11, as the cost assignment unit 46, assigns the low edge cost to the source-side edge of the cluster to which the sunshine label is assigned and assigns the high edge cost to the target-side edge, and assigns the high edge cost to the source-side edge of the cluster to which the shadow label is assigned and assigns the low edge cost to the target-side edge.

In addition, the CPU 11, as the cost assignment unit 46, assigns, to the source-side edge of the cluster to which the unknown label is assigned, the cost depending on the distance between the color information on the cluster and the average value of the color information on the cluster to which the sunshine label is assigned, and assigns, to the target-side edge, the cost depending on the distance between the color information on the cluster and the average value of the color information on the cluster to which the shadow label is assigned.

In step S126, the CPU 11, as the mask generation unit 48, estimates the shadow region by determining whether or not each of the clusters is the shadow region on the basis of the edge cost of the source-side edge and the edge cost of the target-side edge of each of the clusters, and generates the shadow region mask.

As described above, the image correction device according to the present embodiment obtains the pixel position on the image corresponding to each of the three-dimensional points of the three-dimensional point cloud, performs clustering on the pixels of the image on the basis of the pixel values and the pixel positions, obtains the average reflection intensity and the average value of the color information for each cluster, performs comparison in the average reflection intensity and the average value of the color information between the clusters, estimates the shadow region, and corrects the pixel values of the shadow region from the estimated shadow region and the image. As a result, it is possible to accurately estimate the shadow region and correct the image.

In addition, even in a case where variation in the reflection intensity measured by the LiDAR sensor is large, it is possible to perform shadow region estimation in which the influence on the difference in reflectance for each substance is reduced by using the reflection intensity, and it is possible to assign consistent color information in the corrected shadow region and the sunshine region.

In addition, by using the reflection intensity that does not depend on shade and shadow in the image, it is possible to prevent that detection of shadow is omitted due to a substance having a high surface reflectance present in shade, or a substance having a low reflectance present in sunshine is detected as shadow. As a result, when the shadow region is estimated, it is possible to make the estimation less susceptible to a difference in the surface reflectance for each object.

In addition, since the reflection intensity measured by the LiDAR sensor is corrected, it can be used even in the case of a measuring instrument having a large error in reflection intensity.

In addition, in the cluster graph, by extracting the edge between the adjacent clusters having a large difference in the average value of the color information and a small difference in the average reflection intensity, detecting a pair of the sunshine region and the shadow region of the same object, and correcting the Lab value of the shadow region, it is possible to generate a natural image in which a hue of the shadow region and a hue of the sunshine region match.

### <Modifications>

Note that the present invention is not limited to the above-described embodiment, and various modifications and applications can be made without departing from the gist of the present invention.

For example, the case has been described where the three-dimensional point cloud is acquired by the measurement using the LiDAR sensor as an example, but the present invention is not limited thereto. The three-dimensional point cloud may be measured by using a sensor other than the LiDAR sensor.

In addition, various types of processing executed by the CPU reading software (program) in each of the above embodiments may be executed by various processors other than the CPU. Examples of the processors in this case include a graphics processing unit (GPU), a programmable logic device (PLD) whose circuit configuration can be changed after the manufacturing, such as a field-programmable gate array (FPGA), and a dedicated electric circuit that is a processor having a circuit configuration exclusively designed for executing specific processing, such as an application specific integrated circuit (ASIC). In addition, the image correction processing may be executed by one of these various processors or may be executed by a combination of the same processors or two or more different types of processors (for example, a plurality of FPGAs, a combination of a CPU and an FPGA, or the like). In addition, more specifically, a hardware structure of the various processors is an electric circuit in which circuit elements such as semiconductor elements are combined.

In addition, in each of the above embodiments, the aspect has been described in which the image correction program is stored (installed) in advance in the storage 14, but the present invention is not limited thereto. The program may be provided in the form of a program stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Regarding the above embodiments, the following supplementary notes are further disclosed.

### (Supplement 1)

An image correction device including:
a memory;
at least one processor connected to the memory, in which
the processor:
receives an image and a three-dimensional point cloud including three-dimensional points having reflection intensity on a surface of an object for which at least a relationship between an image capturing position and a measurement position is obtained in advance, and obtains pixel positions on the image corresponding to the respective three-dimensional points of the three-dimensional point cloud;
performs clustering on pixels of the image on the basis of pixel values and pixel positions, obtains an average reflection intensity and an average value of quantified color information for each of clusters, and
estimates a shadow region by performing comparison in the average reflection intensity and the average value of the color information between the clusters; and
corrects pixel values of the shadow region from the shadow region estimated and the image.

### (Supplement 2)

A non-transitory storage medium storing a program executable by a computer to execute image correction processing, in which:
the image correction processing includes:
receiving an image and a three-dimensional point cloud including three-dimensional points having reflection intensity on a surface of an object for which at least a relationship between an image capturing position and a measurement position is obtained in advance, and obtaining pixel positions on the image corresponding to the respective three-dimensional points of the three-dimensional point cloud;
performing clustering on pixels of the image on the basis of pixel values and pixel positions, obtaining an average reflection intensity and an average value of quantified color information for each of clusters, and
estimating a shadow region by performing comparison in the average reflection intensity and the average value of the color information between the clusters; and
correcting pixel values of the shadow region from the shadow region estimated and the image.

### REFERENCE SIGNS LIST

10 Image correction device
11 CPU
14 Storage
15 Input unit
16 Display unit
20 Storage unit
22 Intensity correction unit
24 Shadow region estimation unit
26 Shadow correction unit
32 Input processing unit
34 Tensor calculation unit
36 Map generation unit
42 Clustering unit
44 Shadow boundary estimation unit
46 Cost assignment unit
48 Mask generation unit
50 LiDAR sensor
52 Camera

1. An image correction device comprising:
an input processing unit that receives an image and a three-dimensional point cloud including three-dimensional points having reflection intensity on a surface of an object for which at least a relationship between an image capturing position and a measurement position is obtained in advance, and obtains pixel positions on the image corresponding to the respective three-dimensional points of the three-dimensional point cloud;
a shadow region estimation unit that performs clustering on pixels of the image on a basis of pixel values and pixel positions, obtains an average reflection intensity and an average value of quantified color information for each of clusters, and
estimates a shadow region by performing comparison in the average reflection intensity and the average value of the color information between the clusters; and
a shadow correction unit that corrects pixel values of the shadow region from the shadow region estimated and the image.

2. The image correction device according to claim 1, wherein in a case where a difference in the average value of the color information is large and a difference in the reflection intensity is small between adjacent clusters, the shadow region estimation unit estimates that a boundary between the adjacent clusters is a boundary of a shadow region.

3. The image correction device according to claim 2, wherein
the shadow region estimation unit assigns a sunshine label to a cluster having higher luminance, assigns a shadow label to a cluster having lower luminance, and assigns an unknown label to a cluster not including the boundary estimated to be the boundary of the shadow region, among the adjacent clusters sandwiching the boundary estimated to be the boundary of the shadow region, and
in a graph including nodes representing the respective clusters, provides a source-side edge connecting each of the nodes representing the respective clusters to a source node and a target-side edge connecting each of the nodes representing the respective clusters to a target node,
assigns a low edge cost to the source-side edge of a cluster to which the sunshine label is assigned, and assigns a high edge cost to the target-side edge,
assigns a high edge cost to the source-side edge of a cluster to which the shadow label is assigned, and assigns a low edge cost to the target-side edge,
assigns, to the source-side edge of a cluster to which the unknown label is assigned, an edge cost depending on a distance between color information on the cluster and an average value of the color information on the cluster to which the sunshine label is assigned, and assigns, to the target-side edge, an edge cost depending on a distance between the color information on the cluster and an average value of the color information on the cluster to which the shadow label is assigned, and
estimates the shadow region on a basis of the edge cost assigned in the graph.

4. The image correction device according to claim 1, further comprising
a map generation unit that generates a reflection intensity map in which reflection intensity is assigned to each of the pixels of the image on a basis of a difference from reflection intensity of a three-dimensional point corresponding to a pixel position on the image, wherein
the shadow region estimation unit performs clustering on the pixels of the image on a basis of the pixel values, the pixel positions, and the reflection intensity map.

5. The image correction device according to claim 3, wherein the shadow region estimation unit estimates the shadow region by determining whether or not each of the clusters is a shadow region on a basis of an edge cost of the source-side edge and an edge cost of the target-side edge of each of the clusters.

6. An image correction method comprising:
receiving an image and a three-dimensional point cloud including three-dimensional points having reflection intensity on a surface of an object for which at least a relationship between an image capturing position and a measurement position is obtained in advance, and obtaining pixel positions on the image corresponding to the respective three-dimensional points of the three-dimensional point cloud;
performing clustering on pixels of the image on a basis of pixel values and pixel positions, obtaining an average reflection intensity and an average value of quantified color information for each of clusters, and
estimating a shadow region by performing comparison in the average reflection intensity and the average value of the color information between the clusters; and
correcting pixel values of the shadow region from the shadow region estimated and the image.

7. (canceled)

8. The image correction method according to claim 6, wherein in a case where a difference in the average value of the color information is large and a difference in the reflection intensity is small between adjacent clusters, the shadow region estimation unit estimates that a boundary between the adjacent clusters is a boundary of a shadow region.

9. The image correction method according to claim 6, wherein
assigning a sunshine label to a cluster having higher luminance, assigns a shadow label to a cluster having lower luminance, and assigns an unknown label to a cluster not including the boundary estimated to be the boundary of the shadow region, among the adjacent clusters sandwiching the boundary estimated to be the boundary of the shadow region, and
providing a source-side edge connecting each of the nodes representing the respective clusters to a source node and a target-side edge connecting each of the nodes representing the respective clusters to a target node,
assigning a low edge cost to the source-side edge of a cluster to which the sunshine label is assigned, and assigns a high edge cost to the target-side edge,
assigning a high edge cost to the source-side edge of a cluster to which the shadow label is assigned, and assigns a low edge cost to the target-side edge,
assigning to the source-side edge of a cluster to which the unknown label is assigned, an edge cost depending on a distance between color information on the cluster and an average value of the color information on the cluster to which the sunshine label is assigned, and assigns, to the target-side edge, an edge cost depending on a distance between the color information on the cluster and an average value of the color information on the cluster to which the shadow label is assigned, and
estimating the shadow region on a basis of the edge cost assigned in the graph.

10. The image correction method according to claim 6, further comprising
generating a reflection intensity map in which reflection intensity is assigned to each of the pixels of the image on a basis of a difference from reflection intensity of a three-dimensional point corresponding to a pixel position on the image, wherein
performing clustering on the pixels of the image on a basis of the pixel values, the pixel positions, and the reflection intensity map.

11. The image correction method according to claim 8, wherein the shadow region is estimated by determining whether or not each of the clusters is a shadow region on a basis of an edge cost of the source-side edge and an edge cost of the target-side edge of each of the clusters.

12. A computer-readable non-transitory recording medium storing computer-executable program instructions that when executed by a processor cause a computer to execute an image correction program comprising:
receiving an image and a three-dimensional point cloud including three-dimensional points having reflection intensity on a surface of an object for which at least a relationship between an image capturing position and a measurement position is obtained in advance, and obtains pixel positions on the image corresponding to the respective three-dimensional points of the three-dimensional point cloud;
performing clustering on pixels of the image on a basis of pixel values and pixel positions, obtains an average reflection intensity and an average value of quantified color information for each of clusters, and
estimating a shadow region by performing comparison in the average reflection intensity and the average value of the color information between the clusters; and
correcting pixel values of the shadow region from the shadow region estimated and the image.

13. The image correction program generation method according to claim 12, wherein in a case where a difference in the average value of the color information is large and a difference in the reflection intensity is small between adjacent clusters, the shadow region estimation unit estimates that a boundary between the adjacent clusters is a boundary of a shadow region.

14. The image correction program according to claim 12, wherein
assigning a sunshine label to a cluster having higher luminance, assigns a shadow label to a cluster having lower luminance, and assigns an unknown label to a cluster not including the boundary estimated to be the boundary of the shadow region, among the adjacent clusters sandwiching the boundary estimated to be the boundary of the shadow region, and
providing a source-side edge connecting each of the nodes representing the respective clusters to a source node and a target-side edge connecting each of the nodes representing the respective clusters to a target node,
assigning a low edge cost to the source-side edge of a cluster to which the sunshine label is assigned, and assigns a high edge cost to the target-side edge,
assigning a high edge cost to the source-side edge of a cluster to which the shadow label is assigned, and assigns a low edge cost to the target-side edge,
assigning to the source-side edge of a cluster to which the unknown label is assigned, an edge cost depending on a distance between color information on the cluster and an average value of the color information on the cluster to which the sunshine label is assigned, and assigns, to the target-side edge, an edge cost depending on a distance between the color information on the cluster and an average value of the color information on the cluster to which the shadow label is assigned, and
estimating the shadow region on a basis of the edge cost assigned in the graph.

15. The image correction program according to claim 12, further comprising
generating a reflection intensity map in which reflection intensity is assigned to each of the pixels of the image on a basis of a difference from reflection intensity of a three-dimensional point corresponding to a pixel position on the image, wherein
performing clustering on the pixels of the image on a basis of the pixel values, the pixel positions, and the reflection intensity map.

16. The image correction program according to claim 13, wherein the shadow region is estimated by determining whether or not each of the clusters is a shadow region on a basis of an edge cost of the source-side edge and an edge cost of the target-side edge of each of the clusters.

17. The image correction device according to claim 1, further comprising an intensity correction unit, wherein the intensity correction unit assigns reflection intensity to each pixel of the image based on a three-dimensional point cloud group, the image an internal parameter, a projection matrix, and translation vector.

18. The image correction device according to claim 1, further comprising a shadow area estimating unit, wherein the shadow estimating unit corrects the pixel values of the shadow region from the estimated shadow region and the image, and displays the reflection intensity map, a shadow region mask, and the corrected image on a display.

19. The image correction device according to claim 1, wherein the input processing unit projects based on the image, the three-dimensional point group, the internal parameter, the projection matrix, and the translation vector, each of the three-dimensional point group found in the three-dimensional points and performs mapping to find the pixel position on the image corresponding to each three-dimensional point.

20. The image correction device according to claim 1, further comprising a tensor calculator that calculates an anisotropic diffusion tensor that weights the smoothing term based on the image gradient.

21. The image correction device according to claim 1, further comprising a map generation unit that generates a reflection intensity map obtained by assigning a reflection intensity to each pixel of the image.
